(19) United States
(12) Patent Application Publication
(10) Pub. No.: US 2009/0049958 A1
(43) Pub. Date: Feb. 26, 2009

(54) TOOLS FOR DETACHABLY ENGAGING TOOL ATTACHMENTS

(75) Inventors: John B. Davidson, Chicago, IL (US); George F. Charvat, Lombard, IL (US); C. Robert Moon, Joliet, IL (US)

Correspondence Address: BRINKS HOFER GILSON & LIONE, P.O. BOX 10395, CHICAGO, IL, 60610, US

(73) Assignee: JODA Enterprises, Inc.

(21) Appl. No.: 12/194,923

(22) Filed: Aug. 20, 2008

Related U.S. Application Data
(63) Continuation of application No. 11/079,010, filed on Mar. 10, 2005, now abandoned.

(51) Int. Cl. B25B 23/16

(52) U.S. Cl. 81/177.85

(57) ABSTRACT

Tools for detachably engaging a tool attachment are described that include a drive element and a mechanism for altering engagement forces between the tool attachment and the drive element. The mechanism includes a locking element and an actuating element coupled to the locking element.

### FIELD OF THE INVENTION

The present invention relates to hand tools and, in particular, to hand tools provided with quick release mechanisms for detachably engaging tool attachments.

### BACKGROUND

Torque transmitting tools (e.g., wrenches, extension bars) having a coupling end (e.g., a drive stud) configured for detachable coupling to a tool attachment (e.g., a socket, extension bar, universal joint or the like) may be provided with a quick release mechanism configured to allow an operator to select between a tool attachment engaging position, wherein the tool attachment is secured to the coupling end and accidental detachment therefrom is substantially prevented, and a tool attachment releasing position, wherein forces tending to retain the tool attachment on the coupling end are relaxed and/or removed.

In the tools described in U.S. Pat. No. 5,911,800, assigned to the assignee of the present invention, a releasing spring 50 biases a locking pin 24 upwardly to a release position, while an engaging spring 48 of greater spring force biases the locking pin 24 downwardly to an engaging position (e.g., FIGS. 1, 3, and 4; col. 3, line 66 to col. 4, line 20; col. 4, lines 49-59). By lowering a collar 34 towards the drive stud end of the tool, the engaging spring 48 biases locking pin 24 to an engaging position.

In the tools described in U.S. Pat. No. 6,755,100 to Alex Chen, a button 50 is pressed by an operator in order to disengage the end 46 of a latch pin 41 from the tool member 60 to which the tool body was attached (e.g., col. 3, lines 44-53; FIGS. 6 and 7). In this design, the quick release mechanism provided by button 50 is accessible only from one specific side and angle of the tool body, which renders access by an operator difficult during certain applications (e.g., when the tool is used in a tight or constricted space, as is frequently the case).

In the tools described in U.S. Pat. No. 4,768,405 to Michael F. Nickipuck, a sleeve 15 is used to transmit motion to a control bar 14, which in turn acts on a detent (e.g., balls or cylinders) located in the drive portion 12 of the tool (e.g., FIGS. 3-4 and 7-9; col. 4, line 53 to col. 5, line 4). A channel 10 through which control bar 14 extends is machined into the surface of the tool all the way down to the drive portion 12 thereof, which is the portion inserted into a socket attachment (e.g. FIG. 5, col. 4, lines 42-47).

Low manufacturing expense, simplicity of design, and performance reliability are all desirable characteristics to be achieved in the manufacture of tools having quick release mechanisms.

### SUMMARY

The scope of the present invention is defined solely by the appended claims, and is not affected to any degree by the statements within this summary.

A first tool for detachably engaging a tool attachment that embodies features of the present invention includes: (a) a drive element containing an internal passageway extending between a lower portion and an upper portion thereof, wherein the lower portion is configured for insertion in the tool attachment and wherein the upper portion is configured to remain outside the tool attachment; and (b) a mechanism for altering engagement forces between the tool attachment and the drive element. The mechanism includes (a) a locking element at least in part movably disposed in the internal passageway to selectively engage and disengage the tool attachment; and (b) an actuating element coupled to the locking element and positioned on the drive element for longitudinal movement with respect to the drive element between at least one releasing position and at least one engaging position, said actuating element additionally configured for rotation with respect to the drive element. The actuating element initiates forces to disengage the tool attachment when the actuating element is moved to the at least one releasing position.

A second tool for detachably engaging a tool attachment that embodies features of the present invention includes: (a) a drive element including a first end configured for coupling to the tool attachment; and (b) a mechanism for altering engagement forces between the tool attachment and the drive element. The mechanism includes: (a) a locking element containing (i) a first part configured for engaging the tool attachment; and (ii) a second part coupled to the first part to allow relative movement therebetween, said second part received at least partly within the drive element; and (b) an actuating element coupled to the second part, wherein the actuating element is positioned on the drive element for longitudinal movement between at least one releasing position and at least one engaging position. The actuating element defines a first center of mass, the second part defines a second center of mass, and the first center of mass moves relative to the second center of mass as the actuating element moves between the at least one releasing position and the at least one engaging position.

A third tool for detachably engaging a tool attachment that embodies features of the present invention includes: (a) a drive element containing a first end configured for coupling to the tool attachment; and (b) a mechanism for altering engagement forces between the tool attachment and the drive element. The mechanism includes: (a) a locking element containing: (i) a first part configured for engaging the tool attachment; and (ii) a second part coupled to the first part to allow relative movement therebetween; and (b) an actuating element coupled to the second part, wherein the actuating element is positioned on the drive element for longitudinal movement between at least one releasing position and at least one engaging position. At least a portion of the locking element is configured to move with a longitudinal component and is substantially enclosed by the drive element. One of the first and second parts includes a ramp having a raised portion and a lowered portion, and the other of the first and second parts includes a follower positioned to engage the raised and the lowered portions of the ramp in response to respective movements of the actuating element.

A fourth tool for detachably engaging a tool attachment that embodies features of the present invention includes: (a) a drive element containing a first end configured for coupling to the tool attachment; and (b) a mechanism for altering engagement forces between the tool attachment and the drive element. The mechanism includes: (a) a locking element containing: (i) a first part configured for engaging the tool attachment; and (ii) a second part coupled to the first part to allow relative movement therebetween, said second part received at least partly within the drive element and disposed to remain out of locking engagement with the tool attachment; and (b) an actuating element coupled to the second part, wherein the actuating element is positioned on the drive element for longitudinal movement between at least one releasing position and at least one engaging position. The actuating element additionally is rotatable on the drive element over an arc of at least 360 degrees.

A fifth tool for detachably engaging a tool attachment that embodies features of the present invention includes: (a) a drive element containing a first end configured for coupling to the tool attachment; and (b) a mechanism for altering engagement forces between the tool attachment and the drive element. The mechanism includes: (a) a locking element containing: (i) a first part configured for engaging the tool attachment; and (ii) a second part coupled to the first part to allow relative movement therebetween; and (b) an actuating element coupled to the second part, wherein the actuating element is positioned on the drive element for longitudinal movement between at least one releasing position and at least one engaging position. At least a portion of the locking element is configured to move with a longitudinal component and is substantially enclosed by the drive element. The second part is coupled to the actuating element only within a region of the actuating element aligned with a single quadrant of a circumference of the drive element.

A sixth tool for detachably engaging a tool attachment that embodies features of the present invention includes: (a) a drive element containing a first end configured for coupling to the tool attachment; (b) a locking element wherein at least a portion of the locking element is moveable for both engaging and releasing the tool attachment, and wherein said at least a portion of the locking element is configured for contacting the tool attachment; (c) an actuating element positioned on the drive element and coupled to the locking element, wherein the actuating element is rotatable with respect to the drive element through at least 360 degrees; and (d) a single biasing element urging the locking element toward a tool attachment engaging position in which the tool attachment is positively retained against separation from the drive element. The single biasing element is disposed at least in part within the first end of the drive element.

A seventh tool for detachably engaging a tool attachment that embodies features of the present invention includes: (a) a drive element containing a first end configured for coupling to the tool attachment; and (b) a mechanism for altering engagement forces between the tool attachment and the drive element. The mechanism includes: (a) a locking element movably disposed in the drive element to selectively engage and disengage the tool attachment; and (b) an actuating element coupled to the locking element and positioned on the drive element. The actuating element is shaped such that a combination of a longitudinal and a rotational movement of the actuating element is required to move the actuating element from a resting, tool-engaging position to a tool-releasing position.

An eighth tool for detachably engaging a tool attachment that embodies features of the present invention includes: (a) a drive element containing an internal passageway extending between a lower portion and an upper portion thereof, wherein the lower portion is configured for insertion in the tool attachment, wherein the upper portion is configured to remain outside the tool attachment, and wherein the drive element defines a longitudinal axis; and (b) a mechanism for altering engagement forces between the tool attachment and the drive element. The mechanism includes (a) a locking element containing a first coupling surface, wherein the locking element is slidably disposed in the internal passageway; and (b) an actuating element containing a second coupling surface, wherein the actuating element is slidably positioned on the drive element for movement with respect to the drive element along the longitudinal axis between at least one releasing position and at least one engaging position, and wherein the actuating element is additionally configured for rotation with respect to the drive element and the locking element around the longitudinal axis. The actuating element couples to the locking element such that forces are generated that tend to disengage the tool attachment at least when the actuating element is moved to the at least one releasing position.

A ninth tool for detachably engaging a tool attachment that embodies features of the present invention includes: (a) a drive element containing an internal passageway and a first end configured for coupling to the tool attachment; and (b) a mechanism for altering engagement forces between the tool attachment and the drive element. The mechanism includes (a) a locking element; and (b) an actuating element. The locking element includes: (a) a first part slidably disposed in the internal passageway and configured for movement between at least one engaging position and at least one releasing position; and (b) a second part coupled to the first part, wherein the second part is slidably disposed in a cross passageway that intersects at least a portion of the internal passageway. The actuating element is positioned on the drive element and coupled to the second part.

A tenth tool for detachably engaging a tool attachment that embodies features of the present invention includes: (a) a drive element containing a drive stud at an end thereof and a passageway that includes an upper opening and a lower opening, wherein the lower opening is positioned at a portion of the drive stud configured for insertion into the tool attachment; (b) a locking element containing an upper portion and a lower portion, wherein the locking element is configured for movement in the passageway between at least one engaging position and at least one releasing position; and (c) an actuating element slidably positioned on the drive element and configured for movement along a longitudinal axis thereof, wherein the actuating element includes a recess in at least a portion of an inner perimeter thereof. The upper portion of the locking element includes a notch and a first coupling surface, and the upper portion is received at least in part in the recess, such that the first coupling surface couples to the actuating element at least when the actuating element moves the locking element to one or a plurality of the at least one engaging position and the at least one releasing position.

An eleventh tool for detachably engaging a tool attachment that embodies features of the present invention includes: (a) a drive element including a drive stud at an end thereof and a passageway that includes an upper opening and a lower opening, wherein the lower opening is positioned at a portion of the drive stud configured for insertion into the tool attachment; (b) a locking element containing an upper portion and a lower portion, wherein the locking element is configured for movement in the passageway between at least one engaging position and at least one releasing position, wherein the lower portion is configured to engage the tool attachment, and wherein the upper portion includes a notch and a first coupling surface; (c) a biasing element coupled to the locking element and configured for biasing the locking element to the engaging position; and (d) an actuating element slidably positioned on the drive element and configured for movement along a longitudinal axis thereof, wherein the actuating element is rotatable around the longitudinal axis with respect to the drive element and the locking element, and wherein the actuating element includes a recess extending around an inner perimeter of the actuating element and a second coupling surface configured to engage the first coupling surface of the locking element. The first coupling surface couples to the second coupling surface at least when the actuating element moves the locking element to one or a plurality of the at least one engaging position and the at least one releasing position.

A twelfth tool for detachably engaging a tool attachment that embodies features of the present invention includes: (a) a drive element including a lower portion configured for insertion in the tool attachment and an upper portion configured to remain outside the tool attachment; and (b) a mechanism for altering retention forces tending to retain the tool attachment on the drive element. The mechanism includes: (a) a locking element slidably disposed in an internal passageway in the drive element and operative to releasably retain the tool attachment in at least one position of the locking element, wherein the locking element includes a first coupling surface; and (b) an actuating element slidably positioned on the drive element and configured for movement along a longitudinal axis thereof, wherein the actuating element includes a second coupling surface. The first coupling surface extends through opposite sides of the locking element and is configured to couple to the second coupling surface of the actuating element at least when the actuating element is operated to move the locking element to one or a plurality of an engaging position and a releasing position. The actuating element is configured to be rotatable around the longitudinal axis at least when operated by a user.

A thirteenth tool for detachably engaging a tool attachment that embodies features of the present invention includes: (a) a drive element including a lower portion configured for insertion in the tool attachment and an upper portion configured to remain outside the tool attachment; and (b) a mechanism for altering retention forces tending to retain the tool attachment on the drive element. The mechanism includes: (a) a locking element slidably disposed in an internal passageway in the drive element and operative to releasably retain the tool attachment in at least one position of the locking element, wherein the locking element includes an upper portion and wherein the internal passageway extends between a lower opening in the lower portion and an upper opening in the upper portion; and (b) an actuating element slidably positioned on the drive element and configured for movement along a longitudinal axis thereof, wherein the actuating element includes a coupling surface. The upper portion of the locking element is configured to engage the coupling surface of the actuating element. The actuating element is rotatable around the longitudinal axis with respect to the drive element and the locking element.

A fourteenth tool for detachably engaging a tool attachment that embodies features of the present invention includes: (a) a drive element containing an internal passageway and a first end configured for coupling to the tool attachment; (b) a locking element slidably disposed in the internal passageway, wherein the locking element is moveable between at least one engaging position and at least one releasing position, and wherein at least a portion of the locking element is configured for contacting the tool attachment; and (c) an actuating element positioned on the drive element, wherein the actuating element is rotatable with respect to the drive element over at least 360 degrees. The tool contains less than two biasing elements coupled to the locking element and configured to bias the locking element to one or a plurality of the at least one engaging position and the at least one releasing position.

### BRIEF DESCRIPTION OF THE DRAWINGS

FIG. 1 shows a side elevation view in partial cross-section of a first tool embodying features of the present invention, wherein the actuating collar is in a lowered position and the biasing element is removed for clarity.

FIG. 2 shows a side elevation view in partial cross-section of the tool of FIG. 1, wherein the actuating collar is in a raised position.

FIG. 3 shows a side elevation view in partial cross-section of the tool of FIG. 1 showing a biasing element that biases the locking element to the engaging position.

FIG. 4 shows a side elevation view of the locking element of FIG. 1.

FIG. 5 shows a cross-sectional side view of the actuating collar of FIG. 1.

FIG. 6 shows a fragmentary cross-sectional view of a second tool embodying features of the present invention.

FIG. 7 shows a fragmentary cross-sectional view of a third tool embodying features of the present invention.

FIG. 8 shows a fragmentary cross-sectional view of a fourth tool embodying features of the present invention.

FIG. 9 shows a fragmentary cross-sectional view of a fifth tool embodying features of the present invention.

FIG. 10 shows a fragmentary cross-sectional view of a sixth tool embodying features of the present invention in which only the sliding member and actuating element are shown for clarity.

FIG. 11 shows a fragmentary cross-sectional view of a seventh tool embodying features of the present invention in which only the sliding member and actuating element are shown for clarity.

FIG. 12 shows a cross-sectional view of an eighth tool embodying features of the present invention.

FIG. 13 shows a cross-sectional view of a ninth tool embodying features of the present invention.

FIG. 14 shows a detail view of a first configuration of a locking element coupled to a slidable member in accordance with the present invention.

FIG. 15 shows a detail view of a second configuration of a locking element coupled to a slidable member in accordance with the present invention.

FIG. 16 shows a detail view of a third configuration of a locking element coupled to a slidable member in accordance with the present invention.

FIG. 17 shows a detail view of a fourth configuration of a locking element coupled to a slidable member in accordance with the present invention.

FIG. 18 shows a fragmentary cross-sectional view of a tenth tool embodying features of the present invention in an engaging position.

FIG. 19 shows a fragmentary view in elevation of an inner surface of the actuating element shown in FIG. 18.

FIG. 20 shows a fragmentary cross-sectional view of the tool shown in FIG. 18 in a releasing position.

FIG. 21 shows a top view of the tool shown in FIG. 18.

### DETAILED DESCRIPTION

Tools containing quick release mechanisms for detachably engaging tool attachments are described below, which in varying degrees may be characterized by one or more of the following: being simple in construction; requiring only a few, easily manufactured parts; providing easy access to an operator using the tool in a tight and/or restricted workspace; being rugged and reliable in use; automatically accommodating various tool attachments (e.g., sockets, extension bars, universal joints, and the like), including those with and without recesses designed to receive a detent; substantially eliminating any precise alignment requirements; being readily cleanable; presenting a minimum of snagging surfaces; and being low in profile.

Throughout this description and in the appended claims, the following definitions are to be understood:

The term “coupled” and various tenses thereof are intended broadly to encompass both direct and indirect coupling. Thus, first and second parts are said to be coupled together when they are directly connected (e.g. by direct contact) and/or functionally engaged, as well as when the first part is functionally engaged with an intermediate part which is functionally engaged either directly or via one or more additional intermediate parts with the second part. Also, two elements are said to be coupled when they are functionally engaged (directly or indirectly) at some times and not functionally engaged at other times.

The term “engage” and various tenses thereof refer to the application of any forces that tend to create and/or maintain a locking relationship between two or more elements of a tool (e.g., one or more portions of a locking element and one or more portions of a tool attachment) against inadvertent, adventitious and/or undesired disruptive forces (e.g., such as may be introduced during use of the tool), which forces tend to detach the engaged elements from their fixed relationship. It is to be understood, however, that engagement does not imply an interlocking connection that is maintained against every conceivable type and/or magnitude of disruptive force.

The designations “upper” and “lower” used in reference to elements shown in the drawings are applied merely for convenience of description. These designations are not to be construed as absolute or limiting and may be reversed. For the sake of clarity, unless otherwise noted, the term “upper” generally refers to the side of an element that is furthest from whichever coupling end (e.g., a drive stud) is configured to engage with a tool attachment to which the tool is intended to transmit torque (e.g., see FIGS. 1-3). In addition, unless otherwise noted, the term “lower” generally refers to the side of an element that is closest to this coupling end.

The terms “part,” “first part,” “second part,” and the like as used in reference to one or multiple components of a locking element include both single element components (e.g., one monolithically formed element) as well as multi-element collections of components that together constitute a single part.

The phrase “relative movement” as applied to two parts refers to any movement whereby the center of mass of one part moves in relation to the center of mass of another part.

The term “ramp” refers broadly to an element with a surface that is shaped such that relative movement in a first direction between the element and a second element in contact with the surface causes the second element to move in a second direction, different from the first direction. Ramps include both translating ramps such as wedges and rotating ramps such as cams.

The phrase “resting, tool-engaging position” refers to the default position of an actuating element in the absence of applied forces (e.g., manually-applied forces). By way of illustration, representative FIGS. 3, 6-9, and 18 show actuating elements in the resting, tool-engaging position.

Representative embodiments in accordance with the present invention will now be described in reference to the appended drawings. It is to be understood that elements and features of the various representative embodiments described below may be selected and/or combined in different ways to produce additional embodiments that likewise fall within the scope of the present invention. Accordingly, the description provided below, when provided in reference to one or more specific figures, is to be understood as being likewise applicable to other embodiments, including but not limited to those shown in other drawing figures whether or not they are specifically referenced.

FIGS. 1-3 show a first tool 2 embodying features of the present invention. Tool 2 includes a drive element 4 containing a passageway 6, which in some embodiments is oriented diagonally to a longitudinal axis 8 thereof, and a drive stud 10 at a coupling end thereof. Passageway 6 includes an upper opening 12 and a lower opening 14, and the lower opening 14 is positioned at a portion of drive stud 10 configured for insertion into a tool attachment (not shown). As used herein, the phrase “tool attachment” refers to any attachment configured to be coupled to a driving end of a tool, for example, a drive stud coupling end of a tool (e.g., drive stud 10), including but not limited to sockets, universal joints, extension bars, and the like.

The representative tool 2 illustrated in FIGS. 1-3 is designed to be mounted on a wrench (not shown) and to fit into and transmit torque to a socket (not shown). The drive element 4 terminates at its lower end in a drive stud 10 having a lower portion 11 and an upper portion 15. The lower portion 11 is configured for insertion into a socket and defines a typically out-of-round cross-section. Typically, the lower portion 11 has a square, hexagonal or other non-circular shape in horizontal cross section. The upper portion 15 will often define a circular cross section, though this is not required.

Tool 2 further includes a locking element 16 moveably disposed in passageway 6, which includes an upper portion 18 and a lower portion 20 configured to engage a tool attachment (e.g., a socket). As used herein, the phrase “locking element” refers to one or a plurality of coupled components, at least one or more of which is configured for releasably engaging a tool attachment. Thus, this phrase encompasses both single part (e.g., element 16 in FIGS. 1-3) and multi-part assemblies (e.g., one or more pins, detents, biasing elements, etc., examples of which are shown in FIGS. 4-9 described below).

The lower portion 20 of locking element 16 is configured to engage a tool attachment when locking element 16 is in an engaging position, and to relax and/or terminate engagement with the tool attachment when locking element 16 is in a releasing position. The terminus of the lower portion 20 of locking element 16 may be formed in any suitable shape and, for example may be rounded, as shown in U.S. Pat. No. 5,911,800, assigned to the assignee of the present invention, or alternately may be provided with a bevel, such as shown in FIGS. 1-4 hereof. The entire contents of U.S. Pat. No. 5,911,800 are incorporated herein by reference, except that in the event of any inconsistent disclosure or definition from the present application, the disclosure or definition herein shall be deemed to prevail.

Though illustrated as a pin in FIGS. 1-4, locking element 16 may take various shapes, including all manner of regular and irregular geometric and elongated shapes, which may be solid or from multiple pieces, and which may be stiff or flexible. The primary function of locking element 16 is to hold a tool attachment in place on drive stud 10 during normal use, for example when pulled manually by a user. The phrase “engaging position” does not imply locking the tool attachment in place against all conceivable forces tending to dislodge the tool attachment. If desired, the locking element 16 may be provided with an out-of-round cross section and the passageway 6 may define a complementary shape such that a preferred rotational orientation of locking element 16 in passageway 6 is automatically obtained (i.e., the locking element 16, which may be provided as a pin, need not be rotatable in passageway 6).

In some embodiments, as best shown by FIG. 4, the upper portion 18 of locking element 16 includes a notch 22 and a first coupling surface 24 adjacent thereto. As used herein, the phrase “coupling surface” refers to any surface configured to effectuate positioning of the locking element toward a releasing position. Moreover, as used herein, the term “surface” (e.g., as in the above-described “coupling surface” or the “guide surfaces” described below) is intended to include both continuous and non-continuous (e.g., interrupted by one or more gaps) areas, including point, line, and full-surface regions of contact (e.g., between a locking element and an actuating element). In some embodiments, as best shown by FIG. 4, the first coupling surface 24 of locking element 16 defines a hook.

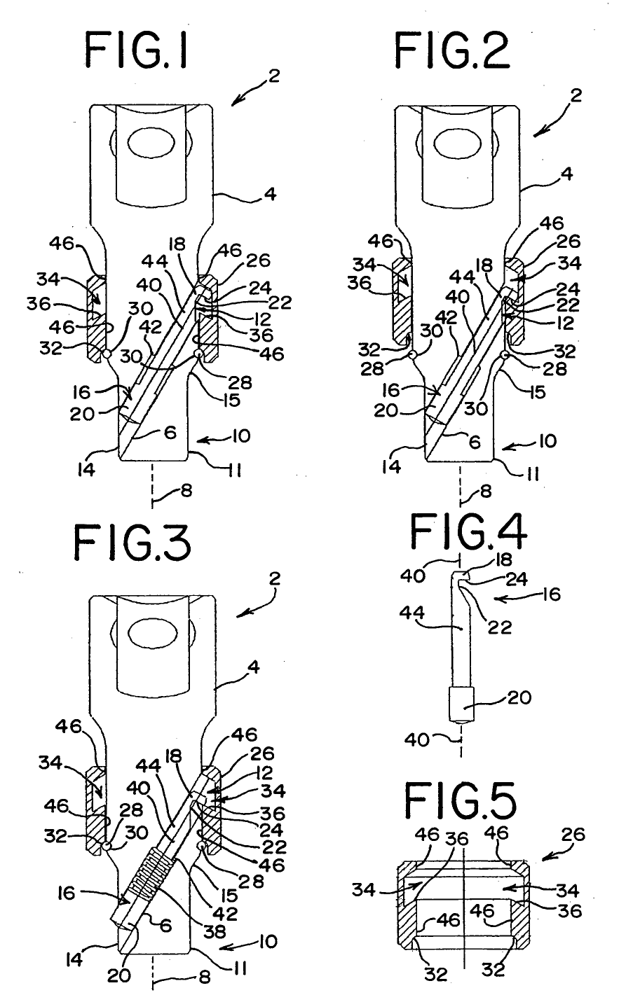

Tool 2 further includes an actuating element 26 slidably positioned on drive element 4 and configured for movement along longitudinal axis 8. As shown in FIGS. 1-3, actuating element 26 may be held in place with a retaining element 28 (e.g., a split ring or C-ring) or any similar type of retention member that may be retained, for example, in a corresponding groove 30 in drive element 4. As illustrated in FIG. 1, actuating element 26 is shown in a lowered position, such that a lower recessed surface 32 of actuating element 26 rests on the retaining element 28, which prevents separation of the actuating element 26 from drive element 4. As illustrated in FIG. 2, actuating element 26 is shown in a raised position in which the lower recessed surface 32 of actuating element 26 no longer contacts retaining element 28.

As shown in FIGS. 1-3, actuating element 26 includes a recess 34 in at least a portion of an inner perimeter thereof. The upper portion 18 of locking element 16 is received at least in part in recess 34, such that first coupling surface 24 may engage with actuating element 26 at least when actuating element 26 is moved towards a releasing position. As used herein, movement of a locking element “toward” a position (e.g., engaging or releasing) or “toward” a particular direction (e.g., to or away from a drive stud) includes all manner of longitudinal and/or skewed motions.

In some embodiments, such as that shown in FIGS. 1-3, recess 34 extends around the inner perimeter of actuating element 26, such that actuating element 26 is freely rotatable (i.e., may be rotated by applying manual and/or automated forces without substantially side-loading and/or damaging the locking element) around longitudinal axis 8 with respect to drive element 4 and locking element 16. Furthermore, in some embodiments, such as that shown in FIGS. 1-3, the upper portion 18 of locking element 16 is received within recess 34 and substantially covered by the actuating element 26.

As shown in FIGS. 1-3, actuating element 26 may be provided as an annular collar that extends around the outer circumferential periphery of drive element 4. It is to be understood that alternative structures, including but not limited to those that extend only partially around the circumference of drive element 4, may likewise be employed. As further shown in FIGS. 1-3, actuating element 26 includes a second coupling surface 36 configured to engage first coupling surface 24 of locking element 16. Thus, raising actuating element 26 in a direction away from drive stud 10 moves lower portion 20 of the locking element 16 coupled thereto out of its tool engaging position (i.e., any position in which the terminus of lower portion 20 projects outwardly from drive stud 10) and further into passageway 6. In some embodiments, as best shown by FIG. 5, the second coupling surface 36 of actuating element 26 defines a lip configured for engaging the hook provided by first coupling surface 24 of locking element 16.

Tool 2 further includes a biasing element 38, such as a spring or the like, which may be configured to bias locking element 16 to one of the engaging and releasing positions. Tools embodying features of the present invention preferably include at least one biasing element, such that automatic engagement with a tool attachment (e.g., by pushing drive stud 10 against a complementary coupling end of the tool attachment) is enabled. In alternative embodiments in which engagement is to be manually initiated by an operator's movement of actuating element 26, no biasing element may be required.

As shown in FIG. 3, biasing element 38 may be a compression spring or the like, which is configured to bias locking element 16 to an engaging position. In alternate embodiments, the compression spring may be implemented in other forms, placed in other positions, and/or integrated with other components. In further alternate embodiments, different types of biasing elements 38 may be used, including but not limited to contracting springs and the like. As shown in FIG. 3, when actuating element 26 is in a lowered position such that lower recessed surface 32 is in contact with retaining element 28, second coupling surface 36 has only minimal or even no surface contact with first coupling surface 24 of locking element 16. However, by raising actuating element 26 (e.g., in a direction away from drive stud 10), the force of contact between second coupling surface 36 and first coupling surface 24 arises and/or is increased and locking element 16 may be pulled upwards and diagonally into passageway 6 against the force of compression spring 38.

As used herein, the phrase “biasing element” refers to any device that can be moved and/or reversibly deformed, such that the movement and/or deformation provides a biasing force against a member mechanically coupled thereto. Representative biasing elements include but are not limited to springs (e.g., elastomeric torsion springs, coil springs, leaf springs, tension springs, compression springs, extension springs, spiral springs, volute springs, flat springs, and the like), detents (e.g., spring-loaded detent balls, cones, wedges, cylinders, and the like), pneumatic devices, hydraulic devices, and the like, and combinations thereof.

In some embodiments, such as that shown in FIGS. 1-3, locking element 16, depicted as a pin in this series of embodiments, defines a centerline 40. In some embodiments, as shown in FIGS. 1-3, first coupling surface 24 and second coupling surface 36 may be oriented substantially perpendicular to centerline 40, such that first coupling surface 24 and second coupling surface 36 are substantially parallel to each other.

In some embodiments, as further shown in FIGS. 1-3, the lower opening 14 of passageway 6 has a cross-sectional area that is larger than a cross-sectional area of upper opening 12, such that a “stop,” for example a shoulder 42, is formed therebetween. As used in this context, the term “stop” refers to a reaction surface for a biasing element, such as the shoulder in the wall of a stepped bore (e.g., shoulder 42) or the dead-end in a biasing element-receiving spur. In such embodiments, biasing element 38 may be positioned between the lower portion 20 of locking element 16 and shoulder 42. In alternative embodiments, the upper opening 12 of passageway 6 may have a cross-sectional area that is larger than the cross-sectional area of lower opening 14 (i.e., a configuration opposite to that shown in FIGS. 1-3) with suitable alterations made to the design of locking element 16.

In some embodiments, as best shown by FIG. 4, locking element 16 may include a neck 44 having a reduced cross-sectional area at notch 22. As used herein, the term “neck” includes all manner of regular and irregular geometric configurations having all manner of cross-sectional shapes. It may be preferable in some embodiments to provide passageway 6 with a constant diameter, and to define shoulder 42 in some other manner, as for example with a plug of the type shown in FIG. 20 of U.S. Pat. No. 4,848,196.

In some embodiments, as best shown by FIG. 4, notch 22 is positioned off-center with respect to centerline 40, faces toward drive stud 10, and may extend from a peripheral portion of locking element 16 past the centerline 40. As best understood in reference to FIG. 4, a cross-section of locking element 16 taken at notch 22 is rotationally asymmetrical about centerline 40.

As shown in FIG. 3, biasing element 38 is a compression spring which bears between shoulder 42 and lower portion 20 of locking element 16, with neck 44 passing through spring 38. In alternate embodiments, the spring may be implemented in other forms, as for example by means of a leaf spring. Furthermore; if a coil spring is used, it may be employed as either a compression or an extension spring with suitable alterations to the design of FIG. 3, and the spring may be eliminated in some embodiments.

As shown in FIGS. 1-3 and 5, actuating element 26 further includes first and second guide surfaces 46 between which is positioned recess 34. Guide surfaces 46 center actuating element 26 on drive element 4 on both sides of the upper portion 18 of locking element 16.

The tool 2 shown in FIGS. 1-3 may be assembled in a straightforward manner. For example, spring 38 may first be placed around neck 44 of locking element 16, and this assembly then placed into passageway 6 via lower opening 14. The spring 38 may then be compressed between the lower portion 20 of locking element 16 and shoulder 42 in passageway 6 to cause the terminus of locking element 16 to recede into passageway 6. Then actuating element 26 may be moved past drive stud 10 and lower opening 14. Locking element 16 may then be moved towards an engaging position to allow actuating element 26 to be moved further along drive element 4 until the upper portion 18 is received in recess 34. Once actuating element 26 is properly seated, retaining element 28 may be fit into groove 30 to hold actuating element 26 on drive element 4. In alternative embodiments, an impact may be used to form an upset on drive element 4 so as to capture actuating element 26 in place. In further alternative embodiments, an upset may be formed on actuating element 26 to capture actuating element 26 in place, or other means such as pins, screws, staking, and the like may be used. This completes assembly of the embodiment shown in FIGS. 1-3 described above.

In the embodiment shown in FIGS. 1-3, the locking element 16 of tool 2 is shown as a pin and is provided as a single part. However, multi-part locking elements may also be used, as further described below in reference to FIGS. 6-9.

FIG. 6 shows a second tool 48 embodying features of the present invention. Tool 48 includes (a) a drive element 50 that includes a lower portion 52 configured for insertion in a tool attachment (not shown) and an upper portion 54 configured to remain outside the tool attachment, and (b) a mechanism for altering retention forces tending to retain the tool attachment on drive element 50. The mechanism includes a locking element 56 and an actuating element 58. Locking element 56 includes a central pin 60 slidably disposed in an internal passageway 62 in drive element 50, a first coupling surface 64 provided by a cross pin 65 extending through opposite sides of central pin 60, and a detent element 66 (e.g., a ball) positioned in a bore 68 in one side of drive element 50.

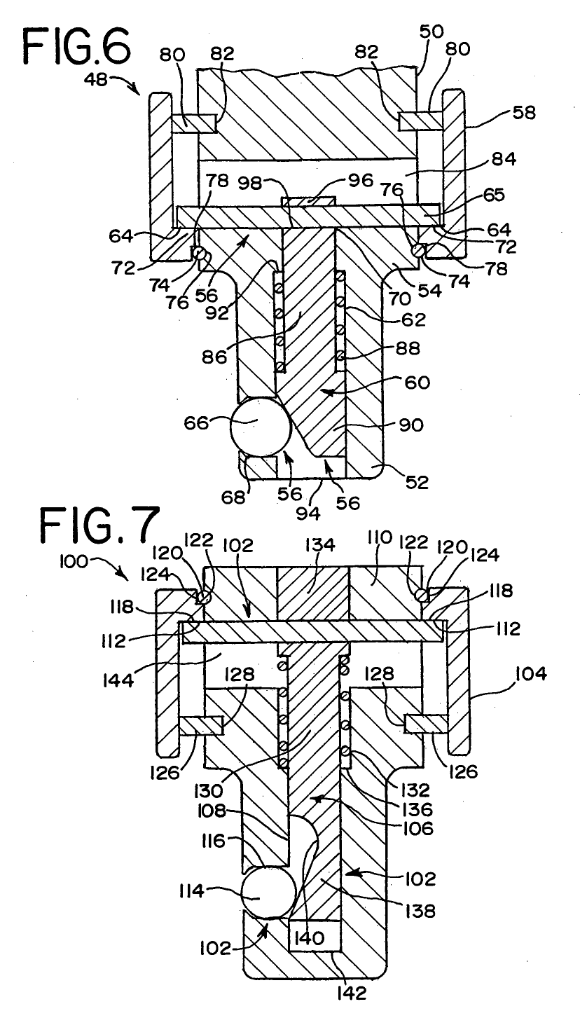

In some embodiments, such as that shown in FIG. 6 and those shown in FIGS. 7-9 described below, a locking element in accordance with the present invention may include at least two independently movable parts. In the embodiment shown in FIG. 6, a first part (e.g., detent ball 66) adjacent lower portion 52 is configured for engaging the tool attachment, and a second part (e.g., first coupling surface 64) adjacent upper portion 54 is configured for engaging actuating element 58.

As used herein, the phrase “internal passageway” refers to a passage substantially enclosed by a drive element along one or more segments of its longitudinal course. It is to be understood that such passageways are not necessarily straight and may include segments of turns, corners, and/or dead ends. Moreover, such passageways may be axially or diagonally aligned within the drive element. In addition, as used herein, it is to be understood that an “internal passageway” may intersect with a channel that does not itself qualify as such, and that not all components of the locking element will be disposed within the “internal passageway.” Furthermore, an “internal passageway” need not be a through bore and may include a dead-end spur (e.g., configured to receive bearing forces from a biasing element).

In some embodiments, the drive stud adjacent the opening of bore 68 is peened, knurled, deformed or machined on all or a portion of its outer edge in order to decrease the outer diameter of the bore 68 and to retain detent ball 66. Alternative configurations for retaining detent ball 66 may also be employed, including but not limited to introducing (e.g., by a press-fit or friction fit) a collar into bore 68.

In some embodiments, first coupling surface 64 may be formed as a single piece with central pin 60. In other embodiments, as shown in FIG. 6, first coupling surface 64 may be provided on a cross pin configured for insertion through a bore 70 in central pin 60.

As shown in FIG. 6, actuating element 58 is slidably positioned on drive element 50 and configured for movement along a longitudinal axis thereof. As further shown in FIG. 6, actuating element 58 includes a second coupling surface 72, such that first coupling surface 64 is configured to be coupled to second coupling surface 72 at least when actuating element 58 is operated to move locking element 56 to a releasing position. Actuating element 58 is rotatable around the longitudinal axis of drive element 50 with respect to lower portion 52 (e.g., a drive stud, as shown in FIG. 6) and the locking element 56.

Analogous to the description provided above in reference to FIGS. 1-3, actuating element 58 of tool 48 may be held in place with a retaining element 74 (e.g., a split ring or C-ring) or any similar type of retention member that may be retained, for example, in a corresponding first groove 76 in drive element 50. As illustrated in FIG. 6, actuating element 58 is shown in a lowered position, such that a lower recessed surface 78 of actuating element 58 rests on the retaining element 74, which prevents separation of actuating element 58 from drive element 50. Actuating element 58 may be centered on drive element 50 by a guide surface 80. As shown in FIG. 6, guide surface 80 may be provided, for example, by a split ring or the like positioned in a corresponding second groove 82 in drive element 50.

In the embodiment shown in FIG. 6, central pin 60 includes a neck 86 having a reduced cross-sectional area, such that a biasing element 88 coupled to locking element 56 may be provided around neck 86 to bear between a lower portion 90 of central pin 60 and a shoulder 92 formed in internal passageway 62. The lower portion 90 of central pin 60 is beveled on at least one side configured to bear against detent ball 66, such that detent ball 66 is in turn configured for engaging a tool attachment. In this embodiment, the lower opening 94 of internal passageway 62 may be open, as shown in FIG. 6, or closed. It is to be understood that alternative configurations of the tool 48 shown in FIG. 6 may also be employed, including but not limited to a configuration in which biasing element 88 is positioned between guide surface 80 and the cross pin extending through bore 70. In the embodiment shown in FIG. 6, biasing element 88 biases locking element 56 toward a tool engaging position. In some embodiments, biasing element 88 is contained within lower portion 52.

In the embodiment shown in FIG. 6, when actuating element 58 is raised, central pin 60 is also raised by the coupling of first coupling surface 64 to second coupling surface 72. In some embodiments, at least a portion of locking element 56 configured for engaging actuating element 58, for example an upper portion 96 of central pin 60 and the first coupling surface 64 provided by the cross pin, are received within a recess or slot 84 above the cross pin and adjacent the second coupling surface 72. In some embodiments, actuating element 58 forms a recess that extends around an inner perimeter of actuating element 58 and that receives the ends of the cross pin.

In some embodiments, as shown in FIG. 6, internal passageway 62 extends between lower opening 94 in lower portion 52 and an upper opening 98 in upper portion 54. One or more portions of internal passageway 62 may be positioned diagonally with respect to the longitudinal axis of drive element 50, as shown in FIGS. 1-3 described above, or parallel to the longitudinal axis as shown in FIG. 6 and FIGS. 7-9 described below.

FIGS. 7-9 show alternative configurations of tools embodying features of the present invention, which are similar in several respects to the tool 48 shown in FIG. 6. All of the preceding description relating to tool 48 shown in FIG. 6 applies equally to the additional embodiments described below in reference to FIGS. 7-9.

FIG. 7 shows a third tool 100 embodying features of the present invention. Tool 100 includes a locking element 102 and an actuating element 104. Locking element 102 includes a central pin 106 slidably disposed in an internal passageway 108 in drive element 110, a cross pin that extends through opposite sides of central pin 106 and that defines a pair of opposed first coupling surfaces 112, and a detent element 114 (e.g., a ball) positioned in a bore 116 in one side of drive element 110.

As shown in FIG. 7, actuating element 104 is slidably and rotatably positioned on drive element 110 and configured for movement along a longitudinal axis thereof. Actuating element 104 includes a second coupling surface 118 configured to couple to first coupling surface 112 at least when actuating element 104 is operated to move locking element 102 to a releasing position.

As shown in FIG. 7, actuating element 104 may be held in place with a retaining element 120 (e.g., a split ring or C-ring) or any similar type of retention member that may be retained, for example, in a corresponding first groove 122 in drive element 110. As illustrated in FIG. 7, actuating element 104 is shown in a raised position, such that an upper recessed surface 124 of actuating element 104 contacts the retaining element 120. Actuating element 104 may be centered on drive element 110 by a guide surface 126. As shown in FIG. 7, guide surface 126 may be provided, for example, by a split ring or the like positioned in a corresponding second groove 128 in drive element 110.

In the embodiment shown in FIG. 7, central pin 106 includes a neck 130 having a reduced cross-sectional area, such that a biasing element 132 (e.g., a compression spring) coupled to locking element 102 may be provided around neck 130 to bear between an upper portion 134 of central pin 106 and a shoulder 136 formed in an interior portion of drive element 110. The lower portion 138 of central pin 106 includes a recess 140 configured to receive detent ball 114 when locking element 102 is moved to a tool attachment releasing position. In this embodiment, lower opening 142 of internal passageway 108 may be closed, as shown in FIG. 7, or open. It is to be understood that alternative configurations of the tool 100 shown in FIG. 7 may also be employed, including but not limited to a configuration in which biasing element 132 is positioned between guide surface 126 and the cross pin, and a configuration in which biasing element 132 is positioned beneath lower portion 138 of central pin 106 (i.e., when lower opening 142 of internal passageway 108 is closed).

In the embodiment shown in FIG. 7, when actuating element 104 is lowered, central pin 106 is also lowered by the coupling of first coupling surface 112 to second coupling surface 118. As central pin 106 is lowered, detent ball 114 is received into recess 140, thereby facilitating tool attachment release. In some embodiments, at least a portion of locking element 102 configured for engaging actuating element 104, for example at least a portion of upper portion 134 of central pin 106 and first coupling surface 112, are received within a recess or slot 144 provided in a space beneath the cross pin that provides first coupling surface 112.

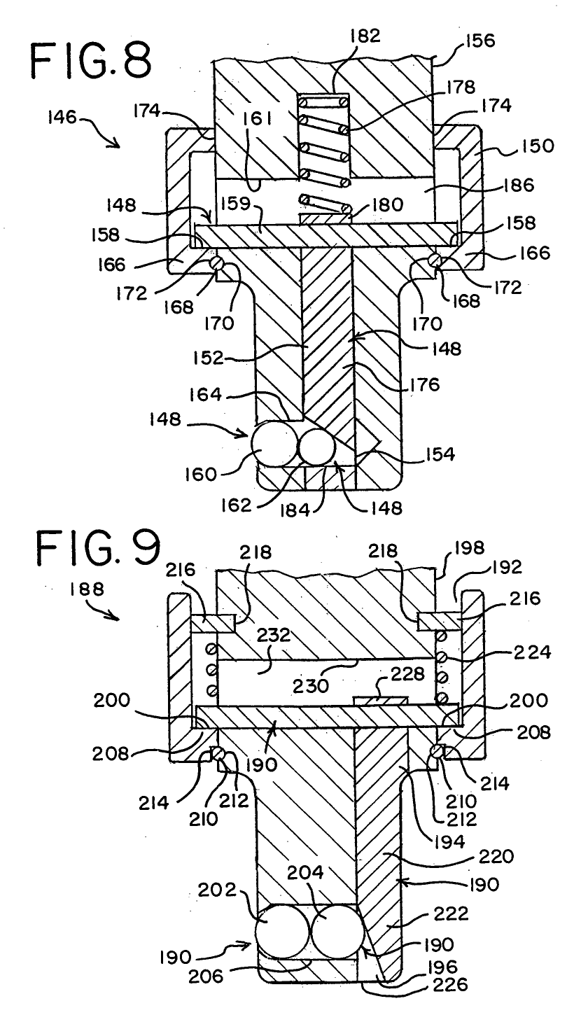

FIG. 8 shows a fourth tool 146 embodying features of the present invention. Tool 146 includes a locking element 148 and an actuating element 150. Locking element 148 includes a central pin 152 slidably disposed in an internal passageway 154 in drive element 156, a cross pin that forms a first coupling surface 158 and that extends through opposite sides of central pin 152, and a pair of detent elements (e.g., balls), 160 and 162, respectively, positioned in a bore 164 in one side of drive element 156.

As shown in FIG. 8, actuating element 150 is slidably and rotatably positioned on drive element 156 and configured for movement along a longitudinal axis thereof. Actuating element 150 includes a second coupling surface 166 configured to couple to first coupling surface 158 at least when actuating element 150 is operated to move locking element 148 to a releasing position.

As shown in FIG. 8, actuating element 150 may be held in place with a retaining element 168 (e.g., a split ring or C-ring) or any similar type of retention member that may be retained, for example, in a corresponding groove 170 in drive element 156. As illustrated in FIG. 8, actuating element 150 is shown in a lowered position, such that a lower recessed surface 172 of actuating element 150 contacts retaining element 168. Actuating element 150 may be centered on drive element 156 by a guide surface 174. As shown in FIG. 8, guide surface 174 may be provided, for example, by forming an upset on the upper portions of actuating element 150.

In the embodiment shown in FIG. 8, central pin 152 has a substantially consistent cross-sectional area along its length and has a bevel at a lower portion 176 that is configured to contact the innermost detent ball 162. As shown in FIG. 8, a biasing element 178 (e.g., a compression spring) coupled to locking element 148 may be provided between an upper portion 180 of central pin 152 and a recess 182 formed in an interior portion of drive element 156. In this embodiment, lower opening 184 of internal passageway 154 is preferably closed, as shown in FIG. 8, as for example by providing a plug in the lower end of drive element 156, which may be either monolithically or separately formed therewith. It is to be understood that alternative configurations of the representative tool 146 shown in FIG. 8 may also be employed, including but not limited to a configuration in which biasing element 178 is provided between an upper surface 159 of the cross pin and a lower internal surface 161 of drive element 156, in which an additional biasing element (not shown) is provided between first and second detent balls, 160 and 162, respectively, and in which other types of regular or irregular geometric shapes of detent elements are employed (e.g., cylindrical members and the like).

In the embodiment shown in FIG. 8, when actuating element 150 is raised, central pin 152 is also raised by the coupling of first coupling surface 158 to second coupling surface 166. As central pin 152 is raised, detent balls 160 and 162 recede into cross bore 164, thereby facilitating tool attachment release. In some embodiments, at least a portion of locking element 148 configured for engaging actuating element 150, for example at least a portion of upper portion 180 of central pin 152 and the cross pin are received within a recess or slot 186 above the cross pin that provides first coupling surface 158.

The tool 146 shown in FIG. 8 may be assembled in a straightforward manner. For example, prior to forming the upset that provides guide surface 174 of actuating element 150, a cross pin that provides first coupling surface 158 is inserted into a corresponding bore in central pin 152 after the latter has been positioned in internal passageway 154. Formation of guide surface 174 completes assembly of tool 146. In an alternative assembly, notches (not shown) may be provided in an upper surface of actuating element 150, which would enable movement of actuating element 150 past the cross pin during assembly.

FIG. 9 shows a fifth tool 188 embodying features of the present invention. Tool 188 includes a locking element 190 and an actuating element 192. Locking element 190 includes a pin 194 slidably disposed in a channel 196 adjacent an edge of drive element 198, a cross pin that defines a pair of first coupling surfaces 200 extends through opposite sides of pin 194, and a pair of detent elements (e.g., balls), 202 and 204, respectively, positioned in a bore 206 in one side of drive element 198. In some embodiments, bore 206 intersects with channel 196.

As shown in FIG. 9, actuating element 192 is slidably and rotatably positioned on drive element 198 and configured for movement along a longitudinal axis thereof. Actuating element 192 includes a second coupling surface 208 configured to couple to first coupling surface 200 at least when actuating element 192 is operated to move locking element 190 to a releasing position.

As shown in FIG. 9, actuating element 192 may be held in place with a retaining element 210 (e.g., a split ring or C-ring) or any similar type of retention member that may be retained, for example, in a corresponding first groove 212 in drive element 198. As illustrated in FIG. 9, actuating element 192 is shown in a lowered position, such that a lower recessed surface 214 of actuating element 192 contacts the retaining element 210. Actuating element 192 may be centered on drive element 198 by a guide surface 216. As shown in FIG. 9, guide surface 216 may be provided, for example, by a split ring or the like positioned in a corresponding second groove 218 in drive element 198 or may, for example, be part of the actuating element 192. Although guide surface 216 is depicted in FIG. 9 as performing two functions—namely, that of a guide surface and that of a bearing surface for the biasing element 224 described below—it is to be understood that alternative configurations in which these two functions are performed by separate elements rather than by the same element are likewise possible.

In the embodiment shown in FIG. 9, pin 194 includes an intermediate portion 220 having a reduced cross-sectional area, and a bevel at a lower portion 222 that is configured to contact the innermost detent ball 204. As shown in FIG. 9, a biasing element 224 (e.g., a compression spring) coupled to locking element 190 may be provided between first coupling surface 200 and guide surface 216. In this embodiment, lower opening 226 of channel 196 may be open, as shown in FIG. 9, or closed. If the area below the base of locking element 190 were closed, the length of the beveled lower portion 222 could be reduced to accommodate the closure surface. It is to be understood that alternative configurations of the tool 188 shown in FIG. 9 may also be employed, including but not limited to a configuration in which an additional biasing element (not shown) is provided between first and second detent balls, 202 and 204, respectively, in which other types of regular or irregular geometric shapes of detent elements are employed (e.g., cylindrical members and the like), and in which biasing element 224 is provided between an upper portion 228 of pin 194 and an interior surface 230 of drive element 198 or elsewhere.

In the embodiment shown in FIG. 9, when actuating element 192 is raised, pin 194 is also raised by the coupling of first coupling surface 200 to second coupling surface 208. Once pin 194 is raised, detent balls 202 and 204 may be free to recede into bore 206, thereby facilitating tool attachment release. In some embodiments, at least a portion of locking element 190 configured for engaging actuating element 192, for example at least a portion of upper portion 228 of pin 194 and the cross pin that forms first coupling surface 200, are received within a recess or slot 232 above the cross pin that provides first coupling surface 200.

In additional embodiments described below, locking elements in accordance with the present invention may include a slidable member coupled to at least one additional part of the locking element (e.g., to a locking pin) and to the actuating element. The slidable member may be, for example, a button analogous to that described in U.S. Pat. No. 6,755,100, the entire contents of which are incorporated herein by reference, except that in the event of any inconsistent disclosure or definition from the present application, the disclosure or definition herein shall be deemed to prevail. In additional embodiments, the slidable member may be provided as a detent element (e.g., a ball). In some embodiments, the slidable member and the second part of the locking element (e.g., a locking pin) coupled thereto may be provided as physically unconnected pieces. In alternative embodiments, the slidable member may be physically tethered to a second part of the locking element, such as by a flexible connecting member similar to the flexible tension member 40 described in U.S. Pat. No. 5,214,986, the entire contents of which are incorporated herein by reference, except that in the event of any inconsistent disclosure or definition from the present application, the disclosure or definition herein shall be deemed to prevail. In these alternative embodiments, the flexible member may be provided as either a compression member or as a tension member, such that a function of the flexible member may be to push or pull one or more parts tethered thereto.

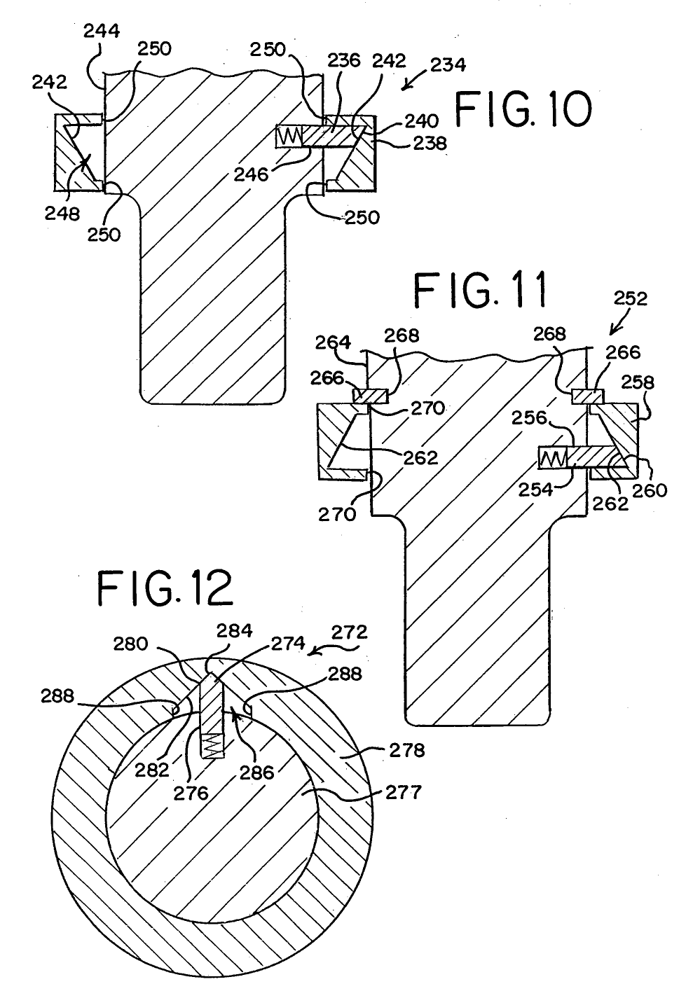

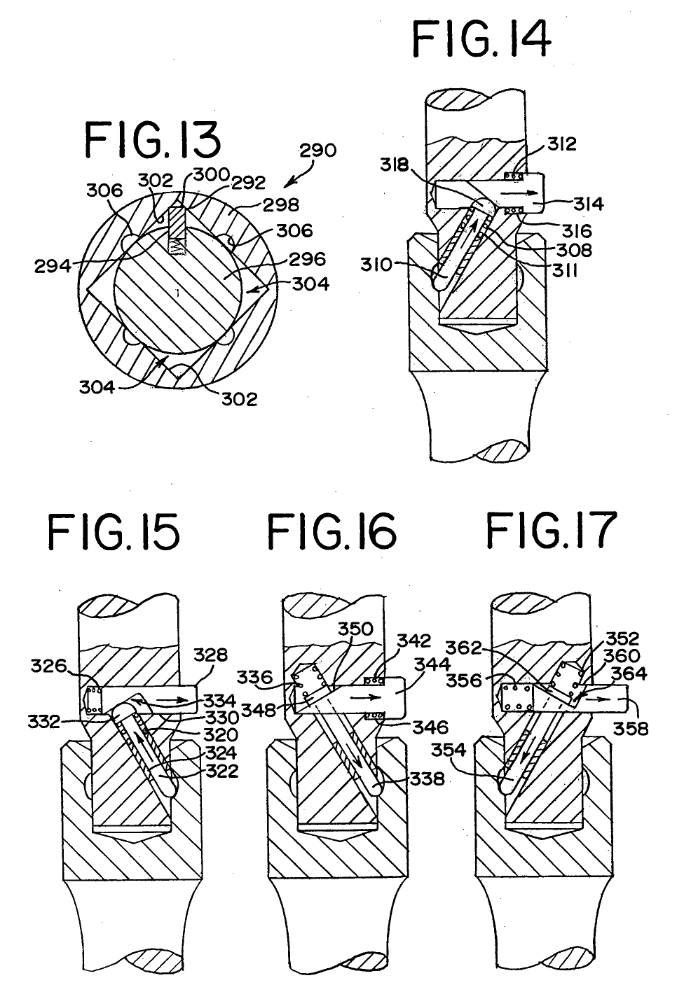

FIGS. 10-13 described below show four representative configurations in which an actuating element may be provided to enable a user to easily manipulate a slidable member coupled thereto without requiring access to a button or similar device from only one specific side and/or angle of the tool body, as was formerly the case with manipulation of the button 50 described in U.S. Pat. No. 6,755,100. Although the configuration described in U.S. Pat. No. 6,755,100 for coupling button 50 to latch pin 41 may be used in accordance with the present invention, additional configurations may likewise be employed. For example, the quick release mechanism described in U.S. Pat. No. 3,208,318 may be modified to include a button-type member similar to that described in U.S. Pat. No. 6,755,100, which is coupled to the operating knob (i.e., reference character 22) shown in FIG. 3 of U.S. Pat. No. 3,208,318. FIGS. 14-17 described below show representative configurations in which a locking element may be coupled to a slidable member. The entire contents of U.S. Pat. No. 3,208,318 are incorporated herein by reference, except that in the event of any inconsistent disclosure or definition from the present application, the disclosure or definition herein shall be deemed to prevail.

As further described below, FIGS. 10-13 show representative configurations for coupling an actuating element to a slidable member in accordance with the present invention. For the sake of clarity, additional elements have been omitted from these drawings, such as those portions of the locking element (e.g., a locking pin, ball, balls or the like) configured to engage a tool attachment. Of course, the configurations shown in FIGS. 10-13 may include additional elements selected from those shown and described herein, including but not limited to one or more elements shown in FIGS. 14-17 and described below. Moreover, it should be noted that biasing elements (e.g., springs) are depicted in FIGS. 10-13 merely for the purpose of indicating that the slidable members act against the force of an actuating element. It is to be understood that such biasing elements need not be located as shown in FIGS. 10-13, and that in some embodiments may be located elsewhere in the system. In some embodiments, biasing elements configured for biasing slidable members may not be biased until a biasing element on the actuating element biases the slidable member inwardly (e.g., embodiments similar to those shown in FIGS. 14 and 16 described below).

FIG. 10 shows a sixth tool 234 embodying features of the present invention. Tool 234 includes a slidable member 236 (e.g., a button, pin, ball or the like), which may be part of a multi-part locking element, and an actuating element 238. In some embodiments, the locking element further includes a pin slidably disposed in an internal passageway of the drive element such as described above in relation to FIGS. 1-3 and 6-9. In some embodiments, it may be desirable for at least a portion of the internal passageway to be positioned parallel to the longitudinal axis, although this is not required in all embodiments. In some embodiments that include a locking pin, the locking pin may be provided as an intermediate part that is coupled to a further part of the locking element, including but not limited to a detent ball.

As shown in FIG. 10, slidable member 236 provides a first part of the locking element and is coupled to the actuating element 238. In a multi-part locking element, slidable member 236 may be further coupled to an upper portion of a second part of the locking element, such as a pin (not shown but analogous to the depiction in FIGS. 6-7 of U.S. Pat. No. 6,755,100). Slidable member 236 includes a coupling surface 240 configured to couple to a coupling surface of the locking pin and to a coupling surface 242 of actuating element 238. If one or more additional locking pins, balls or other locking elements are provided, slidable member 236 may be further configured to couple to the additional locking pin, ball or other locking element.

As shown in FIG. 10, a drive element 244 of tool 234 includes a cross passageway 246 that intersects at least a portion of a channel or an internal passageway (not shown but analogous to the depiction in FIG. 5 of U.S. Pat. No. 6,755,100), such that slidable member 236 is slidably disposed in cross passageway 246. As used herein, the phrase “cross passageway” refers to a passageway at least a portion of which intersects with at least a portion of an internal passageway at any angle. In some embodiments, the angle is an oblique angle while in other embodiments the angle is a right angle. As further shown in FIG. 10, actuating element 238 includes a recess 248 in at least a portion of an inner perimeter thereof. In some embodiments, slidable member 236 is received at least in part in recess 248 and recess 248 extends around the inner perimeter of actuating element 238.

As shown in FIG. 10, each of coupling surface 240 of slidable member 236 and coupling surface 242 of actuating element 238 are shaped to provide a cam action. In some embodiments, the shapes of coupling surfaces 240 and 242 are complementary.

The actuating element 238 shown in FIG. 10 is rotatably positioned on drive element 244 and is also configured for movement along a longitudinal axis thereof. As described above in relation to FIGS. 1-3 and 6-9, actuating element 238 may be held in place on drive element 244 with a retaining element (e.g., a split ring or C-ring) or any similar type of retention member that may be retained, for example, in a corresponding groove in drive element 244. In addition, actuating element 238 may be centered on drive element 244 by first and second guide surfaces 250, such that recess 248 is positioned therebetween.

In the embodiment shown in FIG. 10, coupling surface 240 of slidable member 236 couples to a coupling surface on the locking pin (not shown) or other locking element and to coupling surface 242 of actuating element 238 at least when actuating element 238 is moved to a releasing position. In some embodiments, coupling surface 240 of slidable member 236 is configured to physically contact coupling surface 242 of actuating element 238. Thus, when actuating element 238 is raised, slidable member 236 is pushed further into cross passageway 246, such that the locking element coupled thereto is moved towards a releasing position.

FIGS. 11-13 show alternative configurations of tools embodying features of the present invention, which are similar in several respects to tool 234 shown in FIG. 10. All of the preceding description relating to tool 234 shown in FIG. 10 applies equally to the additional embodiments described below in reference to FIGS. 11-13.

FIG. 11 shows a seventh tool 252 embodying features of the present invention. Tool 252 includes as part of its locking element a slidable member 254 slidably disposed in a cross passageway 256. Tool 252 further includes an actuating element 258. In some embodiments, the locking element further includes a locking pin, such as described above, and slidable member 254 includes a coupling surface 260 configured to couple to a coupling surface of the locking pin (not shown) and to a coupling surface 262 of actuating element 258. In some embodiments, the locking pin may be provided as an intermediate part that is coupled to a further part of the locking element, including but not limited to a detent ball. As described above in relation to FIGS. 1-3 and 6-9, actuating element 258 may be held in place on drive element 264 with a retaining element 266 (e.g., a split ring or C-ring) or any similar type of retention member that may be retained, for example, in a corresponding groove 268 in drive element 264. In addition, actuating element 258 may be centered on drive element 264 by first and second guide surfaces 270.

In some embodiments, each of coupling surface 260 of slidable member 254 and coupling surface 262 of actuating element 258 are beveled, for example in a direction opposite to that shown in FIG. 10. In this configuration, when actuating element 258 is lowered, slidable member 254 is pushed further into cross passageway 256, such that the locking pin coupled thereto is moved towards a releasing position.

FIG. 12 shows an eighth tool 272 embodying features of the present invention. Tool 272 includes (a) a slidable member 274 as part of its locking element, wherein slidable member 274 is slidably disposed in a cross passageway 276 in a drive element 277 and (b) an actuating element 278. In some embodiments, the locking element further includes a locking pin, such as described above, and slidable member 274 includes a coupling surface 280 configured to couple to a coupling surface of the locking pin (not shown) and to a coupling surface 282 of actuating element 278. In some embodiments, the locking pin may be provided as an intermediate part that is coupled to a further part of the locking element, including but not limited to a detent ball. As shown in FIG. 12, an outer portion of slidable member 274 adjacent to actuating element 278 includes a shoulder 284, and actuating element 278 includes a ramped recess 286 in at least a portion of an inner perimeter thereof. In some embodiments, slidable member 274 is received at least in part in recess 286, and the shapes of shoulder 284 and ramped recess 286 are complementary.

Actuating element 278 is rotatable with respect to the drive element 277 about the longitudinal axis of drive element 277. In some embodiments, actuating element 278 is slidably positioned on drive element 277 and further configured for longitudinal movement with respect to the drive element along a direction parallel to the longitudinal axis of drive element 277. Moreover, in some embodiments, rotation of actuating element 278 over ramped recess 286 provides varying degrees of camming between coupling surface 280 and coupling surface 282.

In some embodiments, as shown in FIG. 12, ramped recess 286 extends around only a section of the inner perimeter of actuating element 278 and is provided with stops 288 that prevent 360 degree rotation of actuating element 278 with respect to the longitudinal axis of drive element 277. In other embodiments, ramped recess 286 does not include stops 288 but rather is configured such that actuating element 278 may be rotatable around drive element 277 over 360 degrees with or without substantial camming or impedance.

In the configuration shown in FIG. 12, clockwise or counterclockwise rotation of the actuating element 278 from the orientation that is depicted pushes slidable member 274 further into cross passageway 276, such that the locking element coupled thereto is moved towards a releasing position.

FIG. 13 shows a ninth tool 290 embodying features of the present invention. Tool 290 includes (a) a slidable member 292 as part of its locking element, wherein slidable member 292 is slidably disposed in a cross passageway 294 in a drive element 296 and (b) an actuating element 298. In some embodiments, the locking element further includes a locking pin, as described above, and slidable member 292 includes a coupling surface 300 configured to couple to a coupling surface of the locking pin (not shown) and to a coupling surface 302 of actuating element 298. In some embodiments, the locking pin may be provided as an intermediate part that is coupled to a further part of the locking element, including but not limited to a detent ball. As shown in FIG. 13, actuating element 298 includes a plurality of ramped recesses 304 and a plurality of detent recesses 306 spaced around an inner perimeter thereof. In some embodiments, slidable member 292 is configured to be received in any of the ramped recesses 304 and in any of the detent recesses 306. Detent recesses 306 may be provided to hold the locking element in one or in a plurality of different positions, including one or more engaging positions and one or more releasing positions.

Actuating element 298 is rotatable with respect to the drive element 298 about the longitudinal axis of drive element 296. In some embodiments, actuating element 298 is slidably positioned on drive element 296 and further configured for longitudinal movement parallel to the longitudinal axis of drive element 296. In some embodiments, rotation of actuating element 298 over ramped recess 304 provides varying degrees of camming between coupling surface 300 and coupling surface 302.

In the configuration shown in FIG. 13, clockwise or counterclockwise rotation of the actuating element 298 from the orientation that is depicted initially pushes slidable member 292 further into cross passageway 294, such that the locking pin coupled thereto is moved towards a releasing position. When slidable member 292 becomes aligned with one of the detent recesses 306, the forces pushing it into cross passageway 294 are relaxed and a portion thereof may reemerge to couple with the nearest detent recess 306.

In the embodiments shown in FIGS. 10-13 and described above, the actuating elements are depicted as collars positioned on the drive element. It is to be understood that the configurations of the actuating elements shown and described are merely representative and that additional modifications may be made. By way of example, the actuating elements may control the engagement forces between the tool attachment and the drive element by rotational and/or by longitudinal (i.e., sliding) movement. For embodiments in which the actuating element slides, release of the tool attachment may be achieved either by raising or lowering of the actuating element. In addition, one or more detent positions may be provided in the actuating elements, as shown in FIG. 13, which may be configured to hold the locking element in an engaging position, a releasing position, or both. Furthermore, the actuating element may be retained on the drive element by retaining elements (e.g., lock rings), as shown in FIG. 11, or by the slidable member (e.g., a button). The actuating elements may contain one or more rotational stops, as shown in FIG. 12, and one or more lock positions may likewise be provided. In appropriate embodiments, longitudinal stops may also or alternatively be provided.

As previously noted, the embodiments shown in FIGS. 10-13 may be used with locking pin and button assemblies such as that described in U.S. Pat. No. 6,755,100. However, additional configurations for coupling at least a portion of one part of a locking element (e.g., a pin or ball) and a second part of a locking element (e.g., a slidable member such as a button or ball) may also be employed. Several examples of alternative configurations that may be used in accordance with the present invention will now be described in reference to FIGS. 14-17. In each of these alternative configurations, the locking elements are described for purposes of illustration as including a pin slidably disposed in an internal passageway and a slidable member (e.g., a button) slidably disposed in a cross passageway that intersects at least a portion of the internal passageway. The arrows in FIGS. 14-17 indicate representative directions of biasing of the respective parts of the illustrated locking elements. In each of the embodiments described below, depending on the number and/or type of biasing elements used, the slidable members may be provided on opposite sides of the tool to what is shown in the drawings. In addition, the movement of the slidable members (e.g., a button or ball) may be designed either to engage or to release a tool attachment.

FIG. 14 shows a first configuration for coupling a locking pin to a slidable member in accordance with the present invention. As shown in FIG. 14, a first biasing element 308 (e.g., a compression spring) biases a pin 310 positioned in an internal passageway 311 to a releasing position, and a second biasing element 312 (e.g., a compression spring), optional in this design, biases a slidable member 314 positioned in a cross passageway 316 away from an upper portion 318 of pin 310. In this configuration, pin 310 is biased towards a releasing position until an actuating element (not shown) is operated to press slidable member 314 into cross passageway 316. The actuating element (not shown) is configured to hold slidable member 314 within cross passageway 316, such that an engaging position is maintained. By way of example, an actuating element (e.g., similar to one shown in FIG. 11) could be spring-loaded to provide this support. In the embodiment shown in FIG. 14 and in similar designs in which the locking pin is biased to a releasing position, the actuating element may be necessary in some embodiments to maintain engagement with the tool attachment. In other embodiments, the actuating element may be used merely to initiate a releasing sequence.

FIG. 15 shows a second configuration for coupling a locking pin to a slidable member in accordance with the present invention. As shown in FIG. 15, a first biasing element 320 (e.g., a compression spring) biases a pin 322 positioned in an internal passageway 324 to a releasing position, and a second biasing element 326 (e.g., a compression spring) biases a slidable member 328 positioned in a cross passageway 330 away from an upper portion 332 of pin 322. The slidable member 328 includes a notch 334 in an intermediate portion thereof, which is configured to receive upper portion 332 of pin 322. In this configuration, second biasing element 326 may be provided with a greater spring force than first biasing element 320, such that pin 322 is biased towards an engaging position until an actuating element (not shown) is operated to press slidable member 328 into cross passageway 330. In the embodiment shown in FIG. 15 and in related embodiments (e.g., FIG. 17 described below) wherein locking is achieved by pushing a slidable member (e.g., 328) into a cross passageway (e.g., 330), the locking position may correspond to a rest position of the slidable member, such that unlocking is achieved by withdrawing slidable member 328 from within cross passageway 330.

FIG. 16 shows a third configuration for coupling a locking pin to a slidable member in accordance with the present invention. As shown in FIG. 16, a first biasing element 336 (e.g., a compression spring) biases a pin 338 to an engaging position, and a second biasing element 342 (e.g., a compression spring), optional in this design, biases a slidable member 344 positioned in a cross passageway 346 away from an upper portion 348 of pin 338. The slidable member 344 includes a beveled surface 350 at an end portion thereof, which is configured to contact a complementary beveled surface on the upper portion 348 of pin 338. In this configuration, pin 338 is biased towards an engaging position until an actuating element (not shown) is operated to press slidable member 344 into cross passageway 346. By way of example, an actuating element (e.g., similar to one shown in FIG. 11) could be spring-loaded to provide this support.

FIG. 17 shows a fourth configuration for coupling a locking pin to a slidable member in accordance with the present invention. As shown in FIG. 17, a first biasing element 352 (e.g., a compression spring) biases a pin 354 to an engaging position, and a second biasing element 356 (e.g., a compression spring) biases a slidable member 358 positioned in a cross passageway 360 away from an upper portion 362 of pin 354. In some embodiments, biasing element 356 may be omitted by moving slidable member 358 to the opposite side shown in the drawing. The slidable member 358 includes a notch 364 in an intermediate portion thereof, which is configured to receive upper portion 362 of pin 354. In this configuration, first biasing element 352 may be provided with a greater spring force than second biasing element 356, such that pin 354 does not reach an engaging position until an actuating element (not shown) is operated to press slidable member 358 into cross passageway 360. As described above in reference to FIG. 14, the actuating element (not shown) may be configured to hold slidable member 358 within cross passageway 360, such that an engaging position is maintained.

Furthermore, in some embodiments, the locking pin shown in FIGS. 14-17 and the internal passageway in which it is disposed may be oriented longitudinally (e.g., parallel to the longitudinal axis of the drive element similar to the orientation shown in FIGS. 6-9) as opposed to diagonally. In these alternative embodiments, the longitudinally disposed locking pin may be coupled to one or more detent members (e.g., balls, cylinders or the like) near the end of the tool configured for insertion into a tool attachment, such that the one or more detent members are configured to engage the tool attachment. In some embodiments, a single embodiment includes both diagonal and longitudinal elements or both radial and diagonal or longitudinal elements (e.g., pins or the like).

It is to be understood that the representative configurations for coupling first and second parts of a multi-part locking element (described in connection with FIGS. 14-17 as a pin and a button, respectively, for purposes of illustration) are merely representative and that additional modifications may be made. By way of example, the pin may be biased into or out of the internal passageway in which it is situated. In addition, the pin may exit the drive stud on the same side as the button or on a different side. Furthermore, one or more springs may be used to bias the pin and/or button. The springs may contact the end of the pin and/or button or, alternatively, may engage the pin and/or button at an intermediate portion along the lengths thereof. In addition, the pin may pass through a slot in the button, the button may pass through a slot in the pin or the end of the pin may abut the button. Moreover, engagement forces between the tool attachment and the drive element may be controlled by pushing or pulling the button.

As described above, some embodiments of the tools shown in FIGS. 12-13 include actuating elements configured for both longitudinal and rotational movement. Such embodiments may be further modified such that manipulation of the actuating element between at least one engaging position and at least one releasing position involves both a pulling and a turning motion (e.g., on the part of a user). By way of example, the tool 272 shown in FIG. 12 may be designed such that rotation of actuating element 278 is possible only when actuating element 278 is located at a certain longitudinal position—for example the longitudinal position corresponding to the plane of FIG. 12—or between a certain range of longitudinal positions with respect to drive element 277.

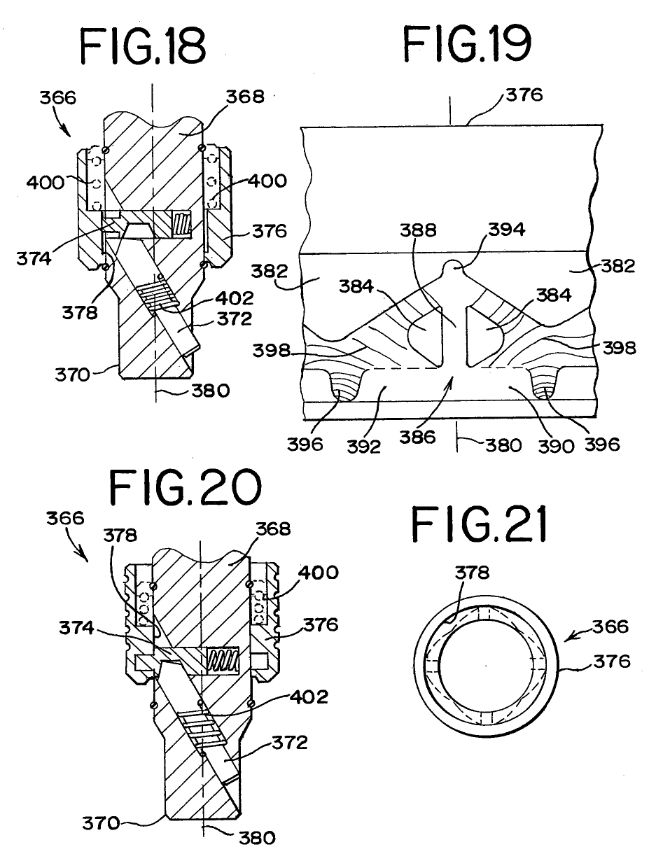

In such designs, actuating element 278 is first moved longitudinally along drive element 277 until shoulder 284 is brought into the plane containing ramped recess 286. At this point, actuating element 278 may then be rotated as described above. Such designs allow a user to readily observe whether a tool is in an engaging position simply by observing appropriate indicia or markings showing whether the actuating element 278 is raised or lowered and/or to what extent. These designs may be particularly desirable in applications involving impact or power tools. In some embodiments, automatic engagement of the tool attachment may be achieved by providing appropriate spring loading of the locking element and/or actuating element (e.g., such that depressing a first end of the tool, such as a drive stud end, onto the tool attachment will result in a self-locking engagement between the drive stud and the tool attachment). FIGS. 19-21 described below illustrate a representative configuration for the types of “pull-and-turn” embodiments described above.

FIGS. 19 and 20 show a tenth tool 366 embodying features of the present invention. Tool 366 includes a drive element 368 having a first end 370 (e.g., a drive stud or the like) configured for coupling to a tool attachment (e.g., a socket or the like, not shown), and a mechanism for altering engagement forces between the tool attachment and the drive element. The mechanism includes a locking element movably disposed in drive element 368 to selectively engage and disengage a tool attachment. In some embodiments, the locking element is similar to the multi-part locking elements shown in FIGS. 10-17 and described above. As shown in FIGS. 18 and 20, the locking element includes a first part 372 (e.g., a locking pin, ball, balls or the like) configured for engaging a tool attachment, and a second part 374 (e.g., a button, pin, ball or the like) coupled to the first part to allow relative movement therebetween. Tool 366 further includes an actuating element 376 coupled to the locking element and positioned on drive element 368.

In some embodiments, first part 372 may be oriented longitudinally (e.g., parallel to the longitudinal axis of the drive element similar to the orientation shown in FIGS. 6-9) as opposed to diagonally. In these alternative embodiments, the longitudinally disposed first part 372 may be coupled to one or more detent members (e.g., balls, cylinders or the like) near first end 370, such that the one or more detent members are configured for engaging the tool attachment. In some embodiments, a single embodiment includes both diagonal and longitudinal elements or both radial and diagonal or longitudinal elements (e.g., pins or the like).

Transitioning between at least one engaging position of actuating element 376 and at least one releasing position involves a combination of both a longitudinal movement and a rotational movement of actuating element 376. As best shown by FIG. 19, which shows the interior surface of approximately one fourth of actuating element 376 in elevation (i.e., an unrolled and flattened view of this inner surface), at least a portion of an inner surface 378 of actuating element 376 includes a topography configured for guiding at least a portion of the second part 374. In FIG. 19, the orientation of longitudinal axis 380 of tool 366 remains unchanged from that shown in FIGS. 18 and 20. The dotted lines connecting portions of FIGS. 18 and 19 align corresponding points in the two drawings.

As shown in FIG. 19, the topography of inner surface 378 comprises first and second raised portions 382 configured such that second part 374 does hot come in contact with the upper surfaces thereof (in this context, the term “upper” assumes a perspective looking down on the plane containing FIG. 19). The topography further includes first and second raised portions 384, which have substantially the same heights to those of raised portions 382. First and second raised portions 384 are likewise configured such that second part 374 does not come in contact with the upper surfaces thereof. Rather, raised portions 384 serve as guides and/or limiters and/or boundaries for second part 374 as further described below.

Inner surface 378 further includes a shallow approximately T-shaped groove 386, which serves to maintain second part 374 in a locked engaging position. T-shaped groove 386 includes a base 388, first arm 390, second arm 392, and a rest position 394 each having substantially the same depth. Inner surface 378 further includes first and second deep wells 396, which are configured to receive second part 374 in its uncompressed configuration (i.e., the configuration corresponding to a maximum protrusion of second part 374 from the exterior circumference of drive element 368). In some embodiments, inner surface 378 includes a plurality (i.e., more than one) of deep wells 396 while in other embodiments, there is only one. In some embodiments, inner surface 378 includes four deep wells evenly spaced around the inner perimeter of actuating element 376. Thus, as shown in FIG. 21, second part 374 may be positioned to occupy any of four deep wells 396 (e.g., as shown by the dotted lines at the twelve, three, six, and nine o'clock positions in the drawing). In some embodiments, deep wells 396 correspond to releasing positions of tool 366.

As shown in FIG. 19, inner surface 378 further includes a ramp 398 bounded by raised portions 382 and 384. Ramp 398 serves to direct second part 374 back to rest position 394 from any of the base 388, first arm 390, and second arm 392. In some embodiments, as shown in FIG. 19, ramp 398 is deepest adjacent to deep wells 396 and shallowest adjacent to rest position 394. In FIG. 19, the proximity of the curved lines in ramp 398 signifies depth, with more closely spaced lines indicating greater depth. Thus, in proximity to deep wells 396, there is a rapid deepening of ramp 398. In addition, the dashed lines in FIG. 19 along the border between first and second arms 390 and 392, respectively, and ramp 398 signify that the depth of ramp 398 in these regions is greater than the depth of the shallow T-shaped groove 386.

FIG. 18 shows tool 366 in an engaging position, while FIG. 20 shows tool 366 in a releasing position. In some embodiments, tool 366 includes a first biasing element 400 (e.g., a compression spring) for biasing actuating element 376 towards an engaging position. In addition tool 366 further includes a second biasing element 402 (e.g., a compression spring), which in some embodiments biases first part 372 towards disengagement from the tool attachment. In the embodiment shown in FIGS. 18 and 20, a biasing force of first biasing element 400 is greater than a biasing force of second biasing element 402. Although the tool 366 shown in FIGS. 18 and 20 is depicted as including a third biasing element 404, which in some embodiments biases second part 374 away from longitudinal axis 380, the use of three biasing elements is not a requirement and is merely representative of some embodiments.

By moving actuating element 376 longitudinally towards first end 370, thereby fully compressing first biasing element 400, second part 374 will be moved from rest position 394 into the shallow groove midway between first arm 390 and second arm 392. From this position, actuating element 376 may be rotated clockwise or counterclockwise. If compression of first biasing element 400 is maintained (i.e., if actuating element 376 is held down and not released prematurely), rotation of actuating element 376 may be continued until such time as second part 374 becomes aligned with one of deep wells 396. When second part 374 aligns with and enters a deep well 396, tool 366 is transitioned to a releasing position wherein any tool attachment engaged with first end 370 may be removed. When the force (e.g., from a user's hand) applied longitudinally to actuating element 376 is removed, second part 374 rides along ramp 398 and returns to rest position 394. Thus, in the representative embodiment described above, tool 366 is configured to engage a tool attachment in the locked position at all times except for when second part 374 is in a deep well 396. This embodiment is designed to prevent inadvertent or undesirably facile detachment of a tool attachment from first end 370, and is particularly desirable for use with power and/or impact tools.

Although the embodiment described above is designed such that actuating element 376 is biased towards locked engagement with a tool attachment in the absence of externally applied forces, a reciprocal configuration in which actuating element 376 is biased towards a releasing position in the absence of applied force is likewise possible. Moreover, the representative topography of inner surface 378 shown in FIG. 19 is merely illustrative, and alternative designs and topographies may also be used to achieve similar results.

Moreover, with minor design modifications, embodiments based on and/or similar to the embodiments shown in FIGS. 18 and 20 provide a full gamut of variations of locking and releasing configurations, including: (a) embodiments in which releasing is achieved by pulling second part 374 or by otherwise causing or allowing second part 374 to move or be moved in a direction away from longitudinal axis 380; (b) embodiments in which locking is achieved by pulling second part 374 or by otherwise causing or allowing second part 374 to move or be moved in a direction away from longitudinal axis 380; (c) embodiments in which releasing is achieved by pushing second part 374 or by otherwise causing or allowing second part 374 to move or be moved in a direction towards longitudinal axis 380; (d) embodiments in which locking is achieved by pushing second part 374 or by otherwise causing or allowing second part 374 to move or be moved in a direction towards longitudinal axis 380; (e) embodiments in which releasing is achieved by raising actuating element 376 in a direction away from first end 370; (f) embodiments in which locking is achieved by raising actuating element 376 in a direction away from first end 370; (g) embodiments in which releasing is achieved by lowering actuating element 376 in a direction towards first end 370; and (h) embodiments in which locking is achieved by lowering actuating element 376 in a direction towards first end 370.

Solely by way of example, if the design shown in FIGS. 18 and 20 is modified such that (a) second part 374 is moved to the opposite side of drive element 368 (i.e., so that second part 374 extends from or is configured to extend from drive element 368 on a side opposite to first part 372), and (b) the topography of inner surface 378 of actuating element 376 is reversed from the representative topography shown in FIG. 19 (e.g., the raised and lowered portions are reversed), a tool may be provided whereby locking is achieved by pulling second part 374 or by otherwise causing or allowing second part 374 to move or be moved in a direction away from longitudinal axis 380.

The operation of engaging a tool attachment to a quick release mechanism in accordance with the present invention will be readily apparent from the preceding description and from FIGS. 1-21. When the lower portion of a first coupling end (e.g., a drive stud) of the tools described above is brought into alignment with a tool attachment (e.g., a socket), the lower end of the locking element 16 shown in FIGS. 1-4 and the locking elements used in FIGS. 10-17, the detent balls 66 and 114 shown in FIGS. 6 and 7, respectively, and the outermost detent balls 160 and 202 shown in FIGS. 8 and 9, respectively, are brought to bear on the tool attachment. The locking elements and detent balls will provide at least frictional engagement even with tool attachments (e.g., sockets) that do not include a complementary recess or that have small or minimal recesses.

In some embodiments described herein, the lower portions of the tools to be detachably engaged with a tool attachment may be engaged with the tool attachment without manipulating the actuating elements in any way.

The locking elements and pins described herein are subjected to diminished side loading as compared to many previous designs even though the actuating element (e.g., a collar) has rotational freedom about the drive element. This is because the illustrated actuating elements are rotationally symmetric about the longitudinal axis of the drive element, such that at least a portion of the rotational stress in relation to the pin is absorbed. Advantages of the representative actuating elements described herein include but are not limited to their accessibility from all sides and angles, and their operability by longitudinal movement (e.g., as opposed to depression and/or rotation).

Embodiments of the present invention may be adapted for use with all manner of torque transmitting tools, including but not limited to hand tools, power tools and impact tools. Simply by way of illustration, the present invention may be used with socket wrenches, including those having ratchets, T-bar wrenches, and speeder wrenches, all as described and shown in U.S. Pat. No. 4,848,196, assigned to the assignee of the present invention, as well as U-joints, flex handles, nut drivers, and extension bars. Furthermore, the present invention is not limited to a particular type or configuration of tool attachment, but may be used with a wide range of tool attachments, including sockets or tool attachments with recesses of various sizes, and sockets or tool attachments without a recess of any type or having small or minimal recesses.

Of course, the quick release mechanisms in accordance with the present invention may be used in any physical orientation, and the terms upper, lower and the like have been used with reference to the illustrative orientations shown in the drawings. Furthermore, the terms “engaging position” and “release position” are each intended to encompass multiple positions within a selected range. For example, in some embodiments, the exact position of the engaging position will vary, for example, with the depth of the recess in the tool attachment, and the exact position of the release position may vary with a variety of factors, including the extent to which the actuating element is moved, and the shape (e.g., square or other) of the female opening in the socket or other tool attachment and/or the shape of any detent provided therein. Moreover, the term “releasing position” is to be understood as referring to any position of an actuating element wherein forces tending towards engagement of a tool attachment are relaxed and/or removed. Thus, as used herein, a releasing position of an actuating element includes positions wherein a tool attachment does not automatically detach from an end (e.g., drive stud) of a tool (e.g., by falling off under the force of gravity) but rather becomes sufficiently loose to allow facile manual removal by a user.

As described above, the present invention may be implemented in many ways, and is not limited to the specific embodiments shown in the drawings. However, by way of illustration, the following details of construction are provided. Of course, these details are in no way intended to limit the scope of this invention.

By way of example, the pins and/or detent elements described herein may be formed of a material such as a steel of moderate to mild temper, and the actuating collars and retainer elements may be formed of any suitable material including but not limited to brass, steel, other alloys, polymeric materials such as plastics, and the like.

From the foregoing description it should be apparent that the objects set forth above have been achieved. In particular, the mechanisms shown in the drawings are low profile with respect to the circumference of the drive elements, are simple to manufacture and assemble, and require relatively few parts. Moreover, the mechanisms are rugged in operation, and may be used to automatically engage a tool attachment as described above. Because of their design, the mechanisms will accommodate various types of sockets and other tool attachments. In the illustrated embodiments, the actuating collars may be gripped at any point on their circumference, and do not require an operator to use a preferred angular orientation of the tool.

In some alternate embodiments, the locking elements described above may be configured to require a positive action on the part of an operator to retract the locking element as a first coupling end of the tool (e.g., a drive stud) is moved into a tool attachment (e.g., a socket). Certain of these embodiments may require recesses in the tool attachments as described above to provide all of or to maximize the functional advantages described.

The foregoing detailed description and accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

1. A tool for detachably engaging a tool attachment comprising:
a drive element comprising an internal passageway extending between a lower portion and an upper portion thereof, wherein the lower portion is configured for insertion in the tool attachment and wherein the upper portion is configured to remain outside the tool attachment; and
a mechanism for altering engagement forces between the tool attachment and the drive element, the mechanism comprising:
a locking element at least in part movably disposed in the internal passageway to selectively engage and disengage the tool attachment; and
an actuating element coupled to the locking element and positioned on the drive element for longitudinal movement with respect to the drive element between at least one releasing position and at least one engaging position, said actuating element additionally configured for rotation with respect to the drive element;
wherein the actuating element initiates forces to disengage the tool attachment when the actuating element is moved to the at least one releasing position.

2. The invention of claim 1 wherein the locking element comprises an upper portion and a lower portion, wherein the lower portion is configured to engage the tool attachment.

3. The invention of claim 2 wherein the actuating element comprises a recess in a surface of the actuating element facing the drive element.

4. The invention of claim 1 wherein the actuating element comprises a recess in a surface of the actuating element facing the drive element.

5. The invention of claim 3 wherein the upper portion of the locking element comprises a notch and a first coupling surface.

6. The invention of claim 5 wherein the upper portion is received at least in part in the recess.

7. The invention of claim 3 wherein the actuating element extends around a circumference of the drive element.

8. The invention of claim 7 wherein the recess extends around an inner perimeter of the actuating element.

9. The invention of claim 1 wherein the actuating element is rotatable on the drive element over an arc of at least 360 degrees.

10. The invention of claim 2 wherein at least one of the upper portion and the lower portion of the locking element comprises a reduced cross-sectional area.

11. The invention of claim 5 wherein the locking element defines a centerline and wherein the centerline passes through the notch.

12. The invention of claim 1 wherein the locking element comprises a first coupling surface and the actuating element comprises a second coupling surface.

13. The invention of claim 1 wherein the actuating element comprises a collar that extends around a circumference of the drive element.

14. The invention of claim 1 wherein the locking element defines a hook, and wherein the actuating element defines a lip positioned to engage the hock.

15. The invention of claim 3 wherein the actuating element further comprises first and second guide surfaces and wherein the recess is positioned therebetween.

16. The invention of claim 15 wherein the first and second guide surfaces center the actuating element on the drive element on both sides of the upper portion of the locking element.

17. The invention of claim 15 wherein the first and second guide surfaces center the actuating element on the drive element on both sides of the recess.

18. The invention of claim 1 wherein the drive element comprises a stop.

19. The invention of claim 18 wherein the tool further comprises a biasing element coupled to the locking element and reacting against the stop, wherein the biasing element biases the locking element towards engagement with the tool attachment.

20. The invention of claim 18 wherein the tool further comprises a biasing element coupled to the locking element and reacting against the stop, wherein the biasing element biases the locking element away from engagement with the tool attachment.

21. The invention of claim 12 wherein the first coupling surface includes a first portion on a first side of the locking element and a second portion on a second side of the locking element, opposite the first side of the locking element.

22. The invention of claim 1 further comprising a biasing element coupled to the locking element, such that the biasing element biases the locking element toward engagement with the tool attachment.

23. The invention of claim 22 wherein the biasing element is positioned at least in part within the drive element.

24. The invention of claim 12 wherein the actuating element comprises a recess adjacent the second coupling surface, said recess receiving at least a portion of the locking element.

25. The invention of claim 24 wherein the actuating element extends around the drive element, and wherein the recess extends around an inner perimeter of the actuating element.

26. The invention of claim 1 wherein the locking element comprises a pin comprising a lower portion configured for engaging the tool attachment and an upper portion configured for coupling to the actuating element.

27. The invention of claim 1 wherein the locking element comprises at least first and second parts.

28. The invention of claim 27 wherein the first part of the locking element is configured for engaging the tool attachment, and wherein the second part of the locking element transmits forces between the actuating element and the first part.

29. The invention of claim 28 wherein the first part comprises a pin and the second part comprises a pushable element extendable outwardly of a perimeter of the drive element.

30. The invention of claim 21 wherein the first coupling surface is formed as a single piece with at least a portion of the locking element.

31. The invention of claim 12 wherein the first coupling surface is formed by a cross pin positioned in a bore in at least a portion of the locking element.

32. The invention of claim 12 wherein the first coupling surface is formed by a cross pin, and wherein at least a portion of the locking element is positioned in a bore in the cross pin.

33. The invention of claim 12 wherein the first coupling surface is provided by a first element at least in part movably disposed in the internal passageway, and wherein the locking element further comprises a second element coupled to an upper portion of the first element, wherein the second element comprises a third coupling surface.

34. The invention of claim 33 wherein the drive element further comprises a cross passageway that intersects at least a portion of the internal passageway, and wherein the second element is at least in part movably disposed in the cross passageway.

35. The invention of claim 33 wherein the first coupling surface is coupled to the second coupling surface via the second element and the third coupling surface, at least when the actuating element is moved to the at least one releasing position.

36. The invention of claim 35 wherein the third coupling surface is configured to contact the second coupling surface.

37. The invention of claim 33 further comprising a first biasing element that biases the first element away from engagement with the tool attachment.

38. The invention of claim 37 further comprising a second biasing element coupled to the second element to provide forces tending to move the second element towards a coupled relationship with the actuating element.

39. The invention of claim 33 further comprising a first biasing element coupled to the first element to provide forces tending to move the first element towards engagement with the tool attachment.

40. The invention of claim 39 further comprising a second biasing element that biases the second element toward the actuating element.

41. The invention of claim 33 wherein the actuating element comprises a recess in a surface of the actuating element facing the drive element.

42. The invention of claim 41 wherein the second element is received at least in part in the recess.

43. The invention of claim 42 wherein the actuating element extends around the drive element.

44. The invention of claim 43 wherein the recess extends around an inner perimeter of the actuating element.

45. The invention of claim 1 wherein the internal passageway extends at least in part diagonally with respect to a longitudinal axis of the drive element.

46. The invention of claim 1 wherein the internal passageway extends at least in part parallel to a longitudinal axis of the drive element.

47. The invention of claim 1 wherein the actuating element is manually operable.

48. A tool for detachably engaging a tool attachment comprising:
a drive element comprising a first end configured for coupling to the tool attachment; and
a mechanism for altering engagement forces between the tool attachment and the drive element, the mechanism comprising:
a locking element comprising:
a first part configured for engaging the tool attachment; and
a second part coupled to the first part to allow relative movement therebetween, said second part received at least partly within the drive element; and
an actuating element coupled to the second part, wherein the actuating element is positioned on the drive element for longitudinal movement between at least one releasing position and at least one engaging position;
wherein the actuating element defines a first center of mass, wherein the second part defines a second center of mass, and wherein the first center of mass moves relative to the second center of mass as the actuating element moves between the at least one releasing position and the at least one engaging position.

49. A tool for detachably engaging a tool attachment comprising:
a drive element comprising a first end configured for coupling to the tool attachment; and
a mechanism for altering engagement forces between the tool attachment and the drive element, the mechanism comprising:
a locking element comprising:
a first part configured for engaging the tool attachment; and
a second part coupled to the first part to allow relative movement therebetween; and
an actuating element coupled to the second part, wherein the actuating element is positioned on the drive element for longitudinal movement between at least one releasing position and at least one engaging position;
wherein at least a portion of the locking element is configured to move with a longitudinal component and is substantially enclosed by the drive element; and
wherein one of the first and second parts comprises a ramp having a raised portion and a lowered portion, and wherein the other of the first and second parts comprises a follower positioned to engage the raised and the lowered portions of the ramp in response to respective movements of the actuating element.

50. A tool for detachably engaging a tool attachment comprising:
a drive element comprising a first end configured for coupling to the tool attachment; and
a mechanism for altering engagement forces between the tool attachment and the drive element, the mechanism comprising:
a locking element comprising:
a first part configured for engaging the tool attachment; and
a second part coupled to the first part to allow relative movement therebetween, said second part received at least partly within the drive element and disposed to remain out of locking engagement with the tool attachment; and
an actuating element coupled to the second part, wherein the actuating element is positioned on the drive element for longitudinal movement between at least one releasing position and at least one engaging position;
wherein the actuating element additionally is rotatable on the drive element over an arc of at least 360 degrees.

51. A tool for detachably engaging a tool attachment comprising:
a drive element comprising a first end configured for coupling to the tool attachment; and
a mechanism for altering engagement forces between the tool attachment and the drive element, the mechanism comprising:
a locking element comprising:
a first part configured for engaging the tool attachment; and
a second part coupled to the first part to allow relative movement therebetween; and
an actuating element coupled to the second part, wherein the actuating element is positioned on the drive element for longitudinal movement between at least one releasing position and at least one engaging position;
wherein at least a portion of the locking element is configured to move with a longitudinal component and is substantially enclosed by the drive element; and
wherein the second part is coupled to the actuating element only within a region of the actuating element aligned with a single quadrant of a circumference of the drive element.

52. The invention of claim 48, 49, 50, or 51 wherein at least part of the locking element is disposed in an internal passageway positioned diagonally with respect to a longitudinal axis of the drive element.

53. The invention of claim 48, 49, 50, or 51 wherein at least part of the locking element is disposed in an internal passageway positioned parallel to a longitudinal axis of the drive element.

54. The invention of claim 48, 49, 50, or 51 wherein the actuating element contacts the second part at least when the actuating element is moved to the at least one releasing position.

55. The invention of claim 48, 49, 50, or 51 wherein the actuating element contacts the second part at least when the actuating element is moved to the at least one engaging position.

56. The invention of claim 48, 49, or 51 wherein the actuating element is rotatable with respect to the drive element about a longitudinal axis of the drive element.

57. The invention of claim 56 wherein the actuating element is rotatable with respect to the drive element over at least 360 degrees.

58. The invention of claim 56 wherein the actuating element comprises a ramped recess facing the drive element, such that at least a portion of the second part is received at least in part within the ramped recess.

59. The invention of claim 58 wherein the ramped recess comprises at least one stop that prevents 360 degree rotation of the actuating element with respect to the drive element about the longitudinal axis.

60. The invention of claim 48, 49, 50, or 51 wherein the actuating element comprises a ramp on an interior portion thereof configured for contacting the second part.

61. The invention of claim 60 wherein the ramp is ramped in a direction that extends around a longitudinal axis of the drive element.

62. The invention of claim 60 wherein the ramp is ramped in a direction that extends along a longitudinal axis of the drive element.

63. The invention of claim 48, 49, 50, or 51 wherein the second part engages the first part.

64. The invention of claim 48, 49, 50, or 51 further comprising a biasing element coupled to the locking element.

65. The invention of claim 64 wherein the biasing element is received at least in part within the drive element.

66. The invention of claim 65 wherein the biasing element is operative to bias the first part of the locking element into engagement with the tool attachment.

67. A tool for detachably engaging a tool attachment comprising:
a drive element comprising a first end configured for coupling to the tool attachment;
a locking element wherein at least a portion of the locking element is moveable for both engaging and releasing the tool attachment, and wherein said at least a portion of the locking element is configured for contacting the tool attachment;
an actuating element positioned on the drive element and coupled to the locking element, wherein the actuating element is rotatable with respect to the drive element through at least 360 degrees; and
a single biasing element urging the locking element toward a tool attachment engaging position in which the tool attachment is positively retained against separation from the drive element;
said single biasing element disposed at least in part within the first end of the drive element.

68. A tool for detachably engaging a tool attachment comprising:
a drive element comprising a first end configured for coupling to the tool attachment; and
a mechanism for altering engagement forces between the tool attachment and the drive element, the mechanism comprising:
a locking element movably disposed in the drive element to selectively engage and disengage the tool attachment; and
an actuating element coupled to the locking element and positioned on the drive element;
said actuating element shaped such that a combination of a longitudinal movement and a rotational movement of the actuating element is required to move the actuating element from a resting, tool-engaging position to a tool-releasing position.

69. The invention of claim 67 further comprising a biasing element coupled to the actuating element to bias the actuating element towards the resting, tool-engaging position.

70. The invention of claim 69 wherein the resting, tool-engaging position is a default position.

71. The invention of claim 68 further comprising a biasing element coupled to the actuating element to bias the actuating element towards the tool-releasing position.

72. The invention of claim 68 wherein at least a portion of an inner surface of the actuating element is shaped to engage the locking element when the actuating element is in a selected range of longitudinal positions and thereby to inhibit rotation of the actuating element.

73. The invention of claim 68 wherein the locking element comprises:
a first part configured for engaging the tool attachment; and
a second part coupled to the first part to allow relative movement therebetween, said second part positioned at least partially within the drive element.

74. The invention of claim 73 wherein at least a portion of an inner surface of the actuating element comprises a topography configured to control a position of the second part with respect to the drive element.

75. The invention of claim 74 further comprising a first biasing element for biasing the actuating element towards the resting, tool-engaging position.

76. The invention of claim 75 further comprising a second biasing element for biasing the first part towards disengagement from the tool attachment, wherein a biasing force of the first biasing element is greater than a biasing force of the second biasing element.

77. The invention of claim 76 wherein the topography comprises at least one recessed portion configured to receive at least a portion of the second part.

78. The invention of claim 77 wherein the topography comprises at least one raised portion configured for engaging the second part to guide the actuating element along at least a portion of a path between the resting, tool-engaging position and the tool-releasing position.

79. The invention of claim 68 wherein an inner surface of the actuating element is shaped such that only when the actuating element is placed in a selected longitudinal position on the drive element can the actuating element be moved to the tool-releasing position with a simple rotary movement.

80. The invention of claim 67 or 68 wherein the locking element is at least in part disposed in a diagonally-extending internal passageway formed in the drive element.

81. The invention of claim 67 or 68 wherein the locking element is at least in part disposed in a longitudinally-extending internal passageway formed in the drive element.

82. The invention of claim 67 or 68 wherein the actuating element extends around the drive element.

83. The invention of claim 82 wherein the actuating element defines a recess facing the drive element, and wherein the locking element extends into the recess.

84. The invention of claim 83 wherein the actuating element forms a ramp for the locking element at the recess, and wherein the ramp is coupled to the locking element.

85. The invention of claim 68 wherein the actuating element is rotatable with respect to the drive element over an arc of at least 360 degrees.
